(19) United States
(12) Patent Application Publication
(10) Pub. No.: US 2022/0300306 A1
(43) Pub. Date: Sep. 22, 2022

(54) ARTIFICIAL INTELLIGENCE BASED COMPUTING SYSTEMS AND METHODS FOR PROVIDING ENHANCED USER HELP

(71) Applicant: BlueOwl, LLC, Bloomington, IL (US)

(72) Inventors: Theobolt N. Leung, San Francisco, CA (US); David Holeman, San Francisco, CA (US); Kenneth J. Sanchez, San Francisco, CA (US)

(21) Appl. No.: 15/883,835

(22) Filed: Jan. 30, 2018

Related U.S. Application Data
(60) Provisional application No. 62/506,908, filed on May 16, 2017.
(60) Provisional application No. 62/516,968, filed on Jun. 8, 2017.

(51) Int. Cl. G06F 9/451; G06F 17/24; G06F 17/21; G06F 17/30; G06N 5/04

(52) U.S. Cl. CPC G06F 9/453; G06F 17/243; G06F 17/212; G06F 17/30867; G06N 5/04

(57) ABSTRACT

A computer system for providing enhanced user help customized to a particular user based upon artificial intelligence includes a processor and a non-transitory, tangible, computer-readable storage medium having instructions stored thereon that, in response to execution by the processor, cause the processor to perform operations including: (i) generating a form-fillable webpage; (ii) providing the form-fillable webpage to a client device for display to a user; (iii) analyzing a user interaction with the form-fillable webpage; and (iv) providing, in response to the analyzing, customized help data to the user in the form-fillable webpage.

### CROSS-REFERENCE TO RELATED APPLICATIONS

This application relates to U.S. Provisional Patent Application No. 62/506,908, filed May 16, 2017, entitled “ARTIFICIAL INTELLIGENCE BASED COMPUTING SYSTEMS AND METHODS FOR PROVIDING ENHANCED USER HELP,” and U.S. Provisional Patent Application No. 62/516,968, filed Jun. 8, 2017, entitled “ARTIFICIAL INTELLIGENCE BASED COMPUTING SYSTEMS AND METHODS FOR PROVIDING ENHANCED USER HELP,” the entire contents and disclosure of which are hereby incorporated herein in their entirety.

### FIELD OF THE INVENTION

The present disclosure relates to systems and methods for providing enhanced user help. More particularly, the present disclosure relates to artificial intelligence based computer systems and methods for providing enhanced user help within a particular application tailored or customized to a particular user, wherein the customized help is provided based upon artificial intelligence.

### BACKGROUND

Many conventional electronic help systems, such as electronic help systems provided with form-fillable webpages, implement a hard-coded help file. This help file may include information considered relevant to one or more data fields included in the form-fillable webpage, and a user may invoke the help file (e.g., through the selection of a “help” option) for the purpose of searching the help file for assistance. In addition, in some cases, help may be provided more dynamically, such as, for example, in the form of a suggestion that appears over a data field when a user moves a mouse cursor over the data field. Such help is not, however, individually customized to the user, nor, for example, is such help provided as a result of an analysis of a user interaction with the webpage. Conventional system may include other drawbacks as well.

### BRIEF SUMMARY

The present embodiments relate to systems and methods that utilize artificial intelligence to provide customized electronic help. The systems and methods may provide tailored or customized online help, and/or provide online help based upon a user interaction with a webpage. For example, artificial intelligence may provide help customized for a particular user based upon data associated with the user (e.g., a user profile) and/or in response to an indication that the user is uncertain about the data requested by a particular data field within a form-fillable webpage. In one embodiment, the platform may include a client device, a web server, a database server, and/or a database. The client device may display a form, such as a form-fillable webpage. The form may be displayed in conjunction with an enhanced user help feature, which may use artificial intelligence to provide help to the user as the user enters data in the form.

In one aspect, a system for providing enhanced user help customized to a particular user and based upon artificial intelligence may be provided. In some exemplary embodiments, the system may include a processor and a non-transitory, tangible, computer-readable storage medium having instructions stored thereon that, in response to execution by the processor, cause the processor to perform operations including: (i) generating a form-fillable webpage; (ii) providing the form-fillable webpage to a client device for display to a user; (iii) analyzing a user interaction with the form-fillable webpage; and/or (iv) providing, in response to the analyzing, customized help data to the user in the form-fillable webpage. The system may include additional, less, or alternate functionality, including that discussed elsewhere herein.

In another aspect, at least one tangible, non-transitory, computer readable storage media having computer-executable instructions embodied thereon, wherein when executed by at least one processor, the computer-executable instructions cause the processor to: (i) generate a form-fillable webpage; (ii) provide the form-fillable webpage to a client device for display to a user; (iii) analyze a user interaction with the form-fillable webpage; and/or (iv) provide, in response to the analyzing, customized help data to the user in the form-fillable webpage. The instructions may direct additional, less, or alternate functionality, including that discussed elsewhere herein.

In yet another aspect, a computer-implemented method for providing electronic help may be provided. The method may include, via one or more local or remote processors, servers, and/or transceivers: (i) generating a form-fillable webpage; (ii) providing the form-fillable webpage to a client device for display to a user; (iii) analyzing a user interaction with the form-fillable webpage; and/or (iv) providing, in response to the analyzing, customized help data to the user in the form-fillable webpage. The method may include additional, less, or alternate actions, including those discussed elsewhere herein.

In yet another aspect, a computer system for providing enhanced user help customized to a particular user and based upon artificial intelligence may be provided. In some exemplary embodiments, the system may include a processor and a non-transitory, tangible, computer-readable storage medium having instructions stored thereon that, in response to execution by the processor, cause the processor to perform operations including: (i) generating a form-fillable webpage that includes a plurality of questions, (ii) providing the form-fillable webpage to a client device for display to a user, (iii) analyzing a user interaction with the form-fillable webpage, (iv) determining, based upon the analyzing, that the user is hesitating to provide an answer to one question of the plurality of questions, (v) analyzing a plurality of user profiles associated with a plurality of other users to identify at least one common answer to the one question, and (vi) providing, in response to the analyzing, customized help data to the user in the form-fillable webpage, wherein the customized help data includes the at least one common answer to the one question. The instructions may direct additional, less, or alternate actions, including those discussed elsewhere herein.

Advantages will become more apparent to those skilled in the art from the following description of the preferred embodiments which have been shown and described by way of illustration. As will be realized, the present embodiments may be capable of other and different embodiments, and their details are capable of modification in various respects. Accordingly, the drawings and description are to be regarded as illustrative in nature and not as restrictive.

### BRIEF DESCRIPTION OF THE DRAWINGS

The Figures described below depict various aspects of the systems and methods disclosed therein. It should be understood that each Figure depicts an embodiment of a particular aspect of the disclosed systems and methods, and that each of the Figures is intended to accord with a possible embodiment thereof. Further, wherever possible, the following description refers to the reference numerals included in the following Figures, in which features depicted in multiple Figures are designated with consistent reference numerals.

There are shown in the drawings arrangements which are presently discussed, it being understood, however, that the present embodiments are not limited to the precise arrangements and are instrumentalities shown, wherein:

FIG. 1 illustrates a schematic diagram of an exemplary computer system for providing enhanced user help customized to a particular user based upon artificial intelligence.

FIG. 2 illustrates an exemplary configuration of a client device shown in FIG. 1, in accordance with one embodiment of the present disclosure.

FIG. 3 illustrates an exemplary configuration of a server shown in FIG. 1, in accordance with one embodiment of the present disclosure.

FIG. 4 illustrates an exemplary process for providing enhanced user help customized to a particular user based upon artificial intelligence.

FIG. 5 illustrates an exemplary form-fillable webpage in which enhanced user help customized to a particular user based upon artificial intelligence is presented.

FIG. 6 illustrates an exemplary computer-implemented method of providing anticipatory user help via a user interface.

FIG. 7 illustrates an alternative exemplary computer-implemented method of providing anticipatory user help via a user interface.

FIG. 8 illustrates another alternative exemplary computer-implemented method of providing anticipatory user help via a user interface.

FIG. 9 illustrates another alternative exemplary computer-implemented method of providing anticipatory user help via a user interface.

The Figures depict preferred embodiments for purposes of illustration only. One skilled in the art will readily recognize from the following discussion that alternative embodiments of the systems and methods illustrated herein may be employed without departing from the principles of the invention described herein.

### DETAILED DESCRIPTION OF THE DRAWINGS

The present embodiments may relate to, inter alia, systems and methods for providing enhanced user help customized to a particular user based upon artificial intelligence. In one exemplary embodiment, the process may be performed by at least one front-end system, such as a client device, and at least one back-end system, such as a web server and/or a database server.

Accordingly, the system may include a client device, such as a personal computing device, a tablet computing device, and/or a mobile communications device. The client device may communicate with the backend system, which may generate and provide a form, such as a form-fillable webpage, to the client device. The client device may display the form for data entry by a user, and, as the user enters data in the form, the client device and/or the backend system may analyze the user's interaction with the form.

For example, the client device and/or the backend system may analyze the user's interaction with the form to determine that the user may be uncertain of data requested by a particular form field in the form. A delay in the user's typing and/or some other observed hesitation by the user may, for instance, suggest that the user is uncertain of the data requested.

In response to such a user delay, the client device and/or the backend system may implement an enhanced user help feature. In some embodiments, the enhanced user help feature may employ artificial intelligence to provide enhanced user help that is customized to the user. For example, the client device and/or the backend system may analyze a user profile associated with the user to provide a suggestion to the user. The suggestion may indicate a potential answer to the data requested by the form, which the user may review for accuracy, and if appropriate, populate or autopopulate in the form.

The suggestion may, in addition, be based upon a variety of other data, such as, for example, data associated with an individual connected to the user (e.g., a spouse or family member of the user), and/or data associated with an individual having user profile attributes similar to those of the user, such as, for example, based upon a collaborative filtering algorithm. In some embodiments, the suggestion may also be based upon the user's interaction with the form to the point of delay or hesitation by the user. For example, if a user has entered a partial address in the form but stops at the zip code associated with the address, the client device and/or backend system may analyze the portion of the address entered by the user to retrieve (e.g., from a database or from the internet) the zip code associated with the partial address.

Thus, the systems and methods described herein function to provide enhanced user help, which may be customized to a particular user, based upon artificial intelligence. The user's interaction with a form, such as a form presented in a form-fillable webpage, may be analyzed, and in response to certain behaviors (e.g., delays in data entry) customized help, such as help based upon data stored in association with the user or one or more other users, may be provided as part of an enhanced help feature to the user.

Exemplary technical effects of the systems, methods, and computer-readable media described herein may include, for example: (a) analyzing a user's interaction with a form, such as a form presented in a form-fillable webpage, to determine that the user may benefit from an enhanced help feature; (b) analyzing a user profile of the user to determine or identify help data that may assist the user in completing the form; (c) analyzing other data, such as data associated with other users, to assist the user in completing the form; and (d) analyzing a user's interaction with the form to a point of detected hesitation or delay to provide help that based upon the data provided by the user to the point of delay or hesitation.

### Exemplary System for Providing Enhanced User Help

As used herein, a “form-fillable webpage” is any webpage that displays one or more data fields and that is configured to receive data or information in connection with the data fields. Thus, a form-fillable webpage is any webpage that includes data fields into which a user may enter data or into which a user may type.

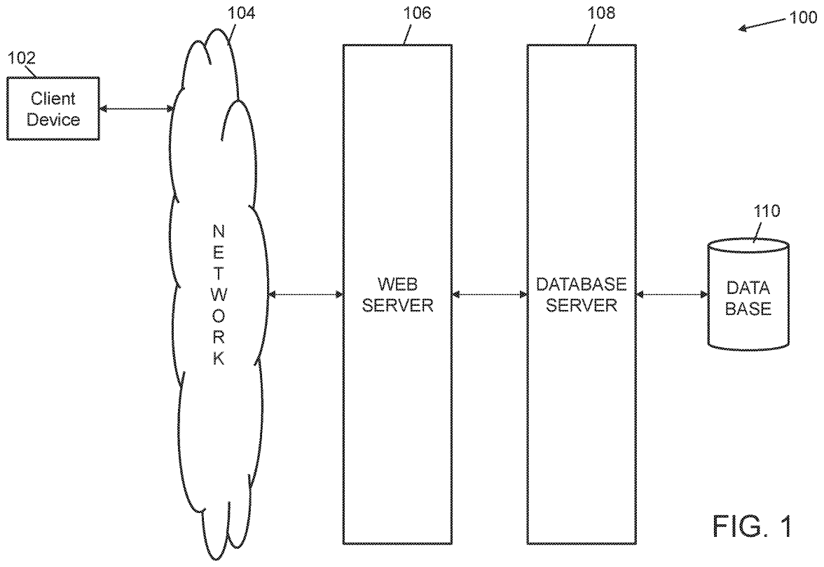

FIG. 1 depicts a view of an exemplary system 100 for providing enhanced user help customized to a particular user based upon artificial intelligence. In one exemplary embodiment, system 100 may include a client device, such as a client device 102. Client device 102 may be associated with an individual, such as a user who has purchased, or who is interested in purchasing, an insurance policy. System 100 may also include network 104, a web server 106, a database server 108, and/or a database 110.

Accordingly, in the exemplary client device 102 may be any personal computing device and/or any mobile communications device of a user, such as a personal computer, a tablet computer, a smartphone, and the like. Client device 102 may be configured to present a webpage, such as a form-fillable webpage. Client device 102 may also be configured to display enhanced user help in association with the webpage. To this end, client device 102 may include or execute software, such as a web browser, for viewing and interacting with a form, such as a webpage or a form-fillable webpage. In some embodiments, client device 102 may be configured to present a mobile application (or an “app”). Where client device 102 displays an app, the app may display a form-fillable webpage, as described herein.

Network 104 may be any electronic communications system, such as any computer network or collection of computer networks, and may incorporate various hardware and/or software. Communication over network 104 may be accomplished via any suitable communication channels, such as, for example, one or more telephone networks, one or more extranets, one or more intranets, the Internet, one or more point of interaction devices (e.g., point of sale devices, smart phones, cellular phones), various online and/or offline communications systems, such as various local area and wide area networks, and the like.

Web server 106 may be any computer or computer system that is configured to receive and process requests made via HTTP. Web server 106 may be coupled between client device 102 and database server 108. More particularly, web server 106 may be communicatively coupled to client device 102 via network 104. In various embodiments, web server 106 may be directly coupled to database server 108 and/or communicatively coupled to database server 108 via a network, such as network 104. Web server 106 may, in addition, function to store, process, and/or deliver one or more web pages, such as one or more form-fillable webpages, and/or any other suitable content to client device 102. Web server 106 may, in addition, receive data, such as data provided to a form-fillable webpage (as described herein) from client device 102 for subsequent transmission to database server 108. Further, in various embodiments and as described in greater detail below, web server 106 may implement artificial intelligence to provide enhanced user help customized to a particular user.

In various embodiments, web server 106 may implement various hardware and/or software, such as, for example, one or more communication protocols, one or more message brokers, one or more data processing engines, one or more servlets, one or more application servers, and the like. For instance, in one embodiment, web server 106 may implement an Internet of Things (IoT) protocol, such as a machine-to-machine IoT communications protocol (e.g. an MQTT protocol). In addition, in various embodiments, web server 106 may implement a message broker program module configured to translate a message or communications from a messaging protocol of a sending device to a messaging protocol of a receiving device (e.g., RABBITTMQ, KAFKA, ACTIVEMQ, KESTREL). Further still, in some embodiments, web server 106 may implement a data processing engine, such as a cluster computing framework like APACHE SPARK. In addition, in various embodiments, web server 106 may implement servlet and/or JSP server, such as APACHE TOMCAT.

Database server 108 may be any computer or computer program that provides database services to one or more other computers or computer programs. In various embodiments, database server 108 may be communicatively coupled between web server 108 and database 110. Database server 108 may, in addition, function to process data received from web server 106, such as biometric data, home data, vehicle data, and/or personal data (as described herein), for storage within database 110.

Database 110 may be any organized collection of data, such as, for example, any data organized as part of a relational data structure, any data organized as part of a flat file, and the like. Database 110 may be communicatively coupled to database server 108 and may receive data from, and provide data to, database server 108, such as in response to one or more requests for data, which may be provided via a database management system (DBMS) implemented on database server 108. In various embodiments, database 110 may be a non-relational database, such as an APACHE HADOOP database.

Although the components of system 100 are described below and depicted at FIG. 1 as being interconnected in a particular configuration, it is contemplated that the systems, subsystems, hardware and software components, various network components, and database systems described herein may be variously configured and interconnected and may communicate with one another within system 100 to facilitate the processes and advantages described herein. Further, although certain functions, processes, and operations are described herein with respect to one or more system components, it is contemplated that one or more other system components may perform the functions, processes, and operations described herein.

### Exemplary Client Device

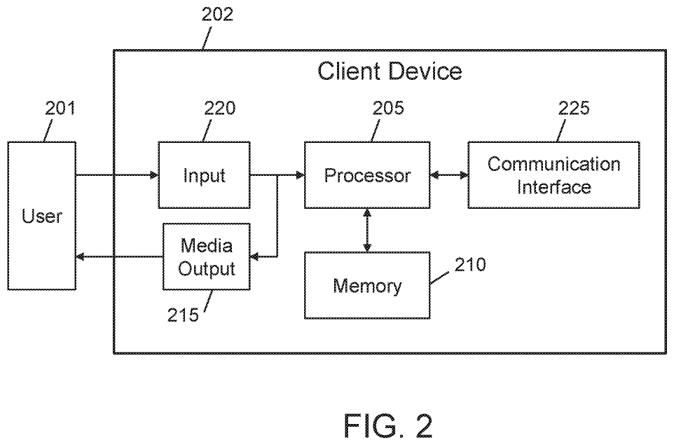

FIG. 2 depicts an exemplary configuration of a client device 202, such as a mobile device or client device 102, as shown in FIG. 1, and in accordance with one embodiment of the present disclosure. Client device 202 may be operated by a user 201. Client device 202 may include a processor 205 for executing instructions. In some embodiments, executable instructions may be stored in a memory area 210. Processor 205 may include one or more processing units (e.g., in a multi-core configuration). Memory area 210 may be any device allowing information such as executable instructions and/or transaction data to be stored and retrieved. Memory area 210 may include one or more computer readable media.

Client device 202 may also include at least one media output component 215 for presenting information to user 201. Media output component 215 may be any component capable of conveying information to user 201. In some embodiments, media output component 215 may include an output adapter (not shown) such as a video adapter and/or an audio adapter. An output adapter may be operatively coupled to processor 205 and adapted to operatively couple to an output device such as a display device (e.g., a cathode ray tube (CRT), liquid crystal display (LCD), light emitting diode (LED) display, or “electronic ink” display) or an audio output device (e.g., a speaker or headphones).

In some embodiments, media output component 215 may be configured to present a graphical user interface (e.g., a web browser and/or a client application) to user 201. A graphical user interface may include, for example, an online store interface for viewing and/or purchasing items, and/or a wallet application for managing payment information. In some embodiments, client device 202 may include an input device 220 for receiving input from user 201. User 201 may use input device 220 to, without limitation, select and/or enter data, such as, for example, one or more report criteria or report filters.

Input device 220 may include, for example, a keyboard, a pointing device, a mouse, a stylus, a touch sensitive panel (e.g., a touch pad or a touch screen), a gyroscope, an accelerometer, a position detector, a biometric input device, and/or an audio input device. A single component such as a touch screen may function as both an output device of media output component 215 and input device 220.

Client device 202 may also include a communication interface 225, communicatively coupled via network 110 to web server 112 (shown in FIG. 1). Communication interface 225 may include, for example, a wired or wireless network adapter and/or a wireless data transceiver for use with a mobile telecommunications network.

Stored in memory area 210 are, for example, computer readable instructions for providing a user interface to user 201 via media output component 215 and, optionally, receiving and processing input from input device 220. A user interface may include, among other possibilities, a web browser and/or a client application. Web browsers enable users, such as user 201, to display and interact with media and other information typically embedded on a web page or a website.

### Exemplary Database System

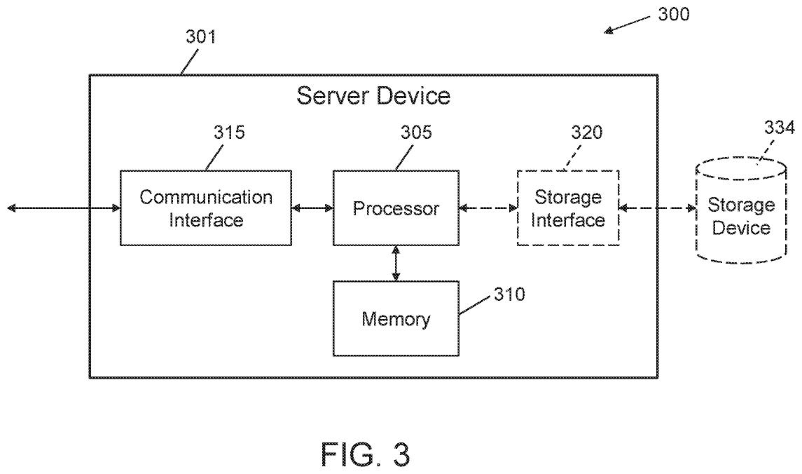

FIG. 3 depicts an exemplary database system 300 such as database server 108 and database 110, as shown in FIG. 1, and in accordance with one exemplary embodiment of the present disclosure. Accordingly, database system 300 may include a server computer device 301 (e.g., database server 114), which may, in turn, include a processor 305 for executing instructions. Instructions may be stored in a memory area 310. Processor 305 may include one or more processing units (e.g., in a multi-core configuration).

Processor 305 may be operatively coupled to a communication interface 315 such that server computer device 301 is capable of communicating with a remote computing device, as described above. For example, communication interface 315 may receive requests from client device 202 via the Internet and/or over a computer network.

Processor 305 may also be operatively coupled to a storage device 334 (e.g., database 116). Storage device 334 may be any computer-operated hardware suitable for storing and/or retrieving data, such as, but not limited to, data associated with database 320. In some embodiments, storage device 334 may be integrated in server computer device 301. For example, server computer device 301 may include one or more hard disk drives as storage device 334.

In other embodiments, storage device 334 may be external to server computer device 301 and may be accessed by a plurality of server computer devices 301. For example, storage device 334 may include a storage area network (SAN), a network attached storage (NAS) system, and/or multiple storage units such as hard disks and/or solid state disks in a redundant array of inexpensive disks (RAID) configuration.

In some embodiments, processor 305 may be operatively coupled to storage device 334 via a storage interface 320. Storage interface 320 may be any component capable of providing processor 305 with access to storage device 334. Storage interface 320 may include, for example, an Advanced Technology Attachment (ATA) adapter, a Serial ATA (SATA) adapter, a Small Computer System Interface (SCSI) adapter, a RAID controller, a SAN adapter, a network adapter, and/or any component providing processor 305 with access to storage device 334.

### Exemplary Process for Providing Enhanced User Help

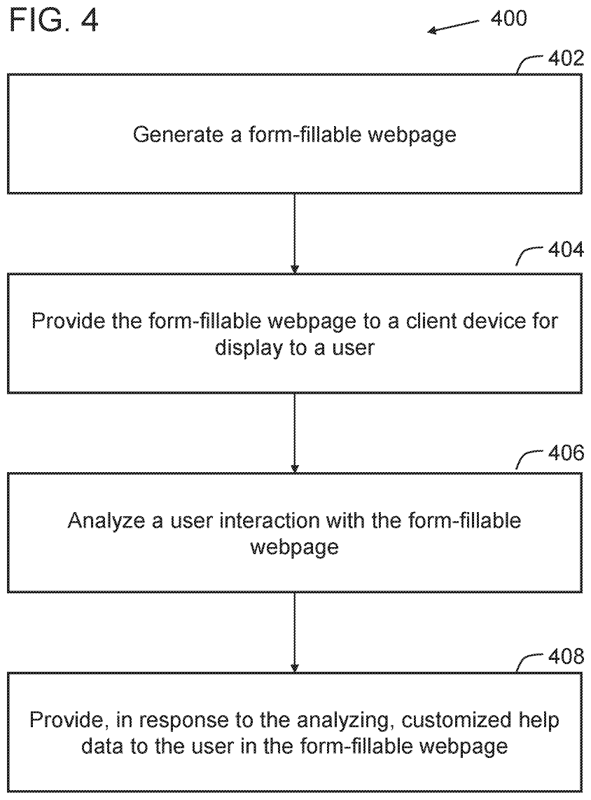

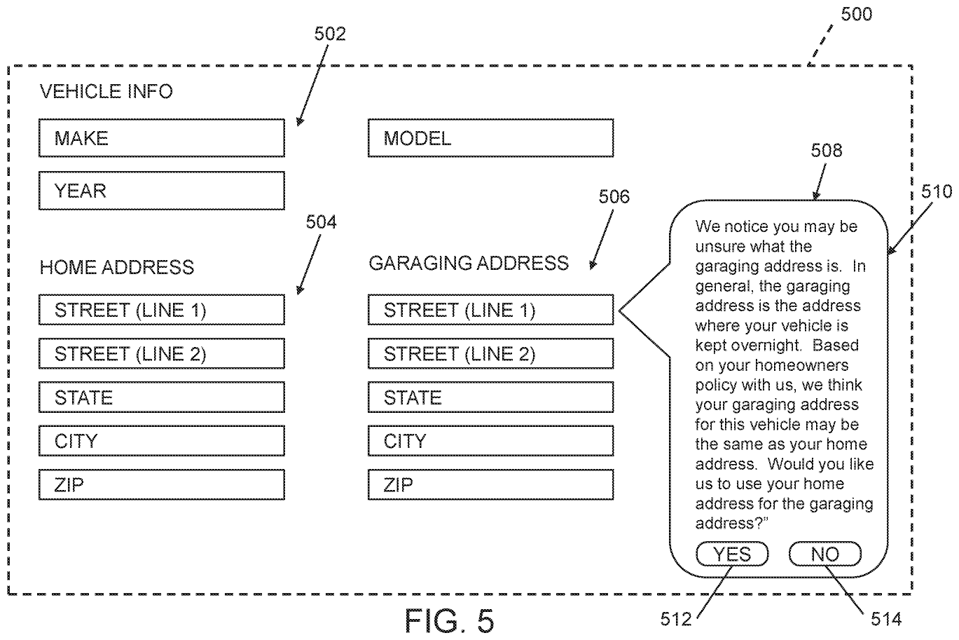

FIG. 4 depicts a flow chart of an exemplary computer-implemented process 400 for providing enhanced user help customized to a particular user based upon artificial intelligence. FIG. 5 illustrates an exemplary form-fillable webpage 500 in which enhanced user help is presented. For convenience, FIG. 4 and FIG. 5 are described in conjunction below.

Accordingly, in the exemplary embodiment, system 100 (e.g., client device, 102, web server 106 and/or database server 108) may display a form. For example, system 100 may generate a webpage, such as form-fillable webpage 500 (step 502). However, in various embodiments, a form may be displayed in any suitable manner, such as in a mobile app and/or in any other online and/or offline computer graphical user interface. Webpage 500 may include a plurality of data fields, such as, for example, a first plurality of data fields 502, a second plurality of data fields 504, and a third plurality of data fields 506. In the exemplary embodiment, webpage 500 displays a form that may be used to collect vehicle information, such as, for example, in conjunction with an application for an auto insurance policy. To this end, in the exemplary embodiment, first plurality of data fields 502 request vehicle information, second plurality of data fields 504 request a home address, and third plurality of data fields 506 request a garaging address.

However, it will be appreciated that webpage 500 is merely illustrative and that webpage 500 may be presented to a user for collecting any suitable data, such as, for example, data associated with an application for auto insurance, data associated with an application for life or health insurance, data associated with an application for homeowners or renters insurance, data associated with an application for personal articles or other types of insurance, data associated with an auto or home loan, data associated with other financial products, and the like. Similarly, although process 500 is described in conjunction with webpage 500 for collecting auto insurance policy information, it will be appreciated that process 500 may be implemented to collect any suitable data, such as, for example, data associated with an application for a life insurance policy, data associated with an application for homeowners or renters insurance, data associated with auto or home loans, data associated with other insurance or financial products, and the like.

In the exemplary embodiment, webpage 500 may, in addition, be provided (e.g., via network 104) to client device 102 (step 404). Webpage 500 may display a plurality of data fields, such as, for example, first plurality of data fields 502, second plurality of data fields 504, and third plurality of data fields 506. The user may thus view webpage 500 as part of an application process, such as, for example, as part of an insurance application process.

System 100 may, in addition, analyze a user interaction with webpage 500 (step 406). For example, client device 102 and/or web server 106 may analyze a user interaction with webpage 500 to determine a delay associated with a particular data field 502, 504, and/or 506. In various embodiments, the delay may be associated with a threshold period of time after a time that the user selects, hovers over, shifts focus to, places a cursor within, begins to enter text, or otherwise interacts with a data field 502, 504, and/or 506.

The delay may, in addition, be measured from a time that the user selects or interacts with a data field 502, 504, and/or 506 to a time that the user enters data in the data field. If a user does not enter data in the data field 502, 504, and/or 506, measurement may continue until focus shifts away from the data field 502, 504, and/or 506 (e.g., until the user selects a different data field 502, 504, and/or 506) and/or until the user closes webpage 500.

Such a delay may indicate, for example, that the user is unsure how to interact with the data field 502, 504, and/or 506. More particularly, a delay may suggest that the user does not know what data is being requested in association with a particular data field 502, 504, and/or 506, or that the user does not have the requested data readily available. Thus, in the exemplary embodiment, the threshold period of time associated with a delay may be any amount of time that suggests that the user may be confused or uncertain. In the exemplary embodiment, the threshold period of time may be within the range of one to five seconds.

Notably, however, and in various embodiments, the delay may not be associated with a processing delay, such as a period of time associated with a determination that focus has shifted to data field 502, 504, and/or 506. Rather, the delay may be measured from a time that focus shifts to data field 502, 504, and/or 506. Thus, the delay may suggest that the user is hesitating or uncertain of the data requested by data field 502, 504, and/or 506. In this respect, system 100 may implement artificial intelligence to analyze a user interaction with webpage 500, including, for example, to determine that the user is hesitating or uncertain of the data requested by a particular data field.

In addition, in the exemplary embodiment, computer system 100 may provide enhanced user help tailored or customized to the user in webpage 500 (step 408). This enhanced user help may be based upon artificial intelligence, such as, for example, based upon an analysis of data stored in association with the user, such as user profile data, data entered by the user in webpage 500 prior to a determination that the user is uncertain of the data requested by a particular data field, data stored in association with an individual associated with the user (such as a spouse or family member of the user), data entered by other users having profile attributes similar to profile attributes of to the user (e.g., as part of a collaborative filtering algorithm), and/or any other data that may be analyzed in conjunction with the user's activity on webpage 500 to provide enhanced user help customized to the user.

For example, web server 106 and/or database server 108 may retrieve and analyze a stored user profile associated with the user to determine one or more attributes of the user, such as, for example, vehicle information associated with the user, a home address of the user, a garaging address of the user, and the like. In other words, system 100 may retrieve and analyze a stored user profile of the user to determine attributes of the user that are already known to system 100, and these attributes may be used to provide customized help data to the user, such as, for example, in response to a determination, as described above, that the user may be unsure of the data requested by a particular data field, 502, 504, and/or 506. Specifically, customized help data may be provided to the user in webpage 500 in response to a delay by user (as described above).

For example, as shown with reference to FIG. 5, customized help data 508 may be provided in association with data field 506, which may request a garaging address of the user. In some instances, a user may be uncertain of the meaning of the term “garaging address,” particularly as the term may differ from the term “home address.” In general, the garaging address may be the location where the user's vehicle (e.g., the vehicle for which the user is purchasing auto insurance through webpage 500) is garaged, or kept overnight. In some regions, the garaging address may differ from the home address, such as, for example, in the instance that the user keeps the vehicle garaged at a location different from the user's home address.

To assist the user in entering data in data field 506, system 100 (e.g., web server 106 and/or database server 108) may analyze the user's interaction with data field 506, and in response to a determination that the user may be uncertain of the data requested in association with data field 506 (e.g., a delay, as described above), system 100 may provide customized help data, such as data based upon the user's profile, to the user. For example, as shown, system 100 may instantiate a suggestion, such as a pop-up 510, which may include customized help data 508. For example, in this case, system 100 may instantiate pop-up 510, which may indicate that system 100 has determined that the user may be uncertain of the data requested and which may, based upon the user profile, suggest that the garaging address is the same as the user's home address. System 100 may further provide an option to populate data field 506 with data from data field 504 (e.g., the user's home address). The user may select a “yes” option 512 and/or a “no” option 514, as shown, to populate data field 506 with the user's home address.

System 100 may further determine that the user's garaging address may be the same as the user's home address based upon the user profile of the user. For example, system 100 may analyze the user's home address to determine that the user resides in a suburban area. In such a case, system 100 may determine that the user's garaging address is likely the same as the user's home address and may, as a result, provide the option, as described above, the populate data field 506 with the user's home address. On the other hand, where system 100 determines that the user's home address is located within an urban region, system 100 may determine that the user's home address may not be identical to the user's garaging address, in which case system 100 may provide a different recommendation in association with data field 506.

Further, in various embodiments, system 100 may provide a definition and/or other non-tailored data to a user in association with data field, such as one or more of data fields 502, 504, and/or 506. For example, system 100 may provide non-tailored or non-customized data, such as a definition of a term (e.g., the term “garaging address”) to a user based upon an analysis of the user's interaction with data field 502, 504, and/or 506. Such definitions may be stored within a database (such as a database coupled to database server 108) and/or hardcoded into webpage 500. A definition of the term “garaging address” is illustrated at pop-up 510.

Thus, in general terms, system 100 may analyze a user profile of a user to provide customized (or non-customized) help to the user. The help may be customized in any suitable manner, and it will be appreciated that the example provided above is merely provided as one illustrative example. In other cases, system 100 may provide any help that is customized to the user based upon the user profile, such as, for example, in the case of a form-fillable webpage for a health insurance application, various biometric data associated with the user (if known by system 100), and the like. Further, in various embodiments, customized help data may be provided to the user based upon personally identifiable information (e.g., PII) of the user that is known to or otherwise stored by system 100.

In addition, in various embodiments, system 100 may implement a collaborative filtering algorithm to provide customized help data to the user. For example, system 100 may analyze a user profile of the user in conjunction with one or more other user profiles associated with other users to provide customized help data, such as a recommendation of data to be entered by the user in one of data fields 502, 504, and/or 506. The customized help data provided to the user may therefore be based upon data other users.

For example, system 100 may, as described above, determine that a user may be uncertain of data requested by one of data fields 502, 504, and/or 506. In response, system 100 may implement a collaborative filtering algorithm to determine what one or more other users having at least some similar user profile attributes entered in data field 502, 504, and/or 506. Where, for example, a user's profile indicates that the user has a spouse who resides with the user, system 100 may implement a collaborative filtering algorithm to determine that the user's garaging address may be the same as the garaging address selected by the user's spouse in the spouse's application for auto insurance. Thus, in general terms, customized help data may be provided based upon a user profile of another user, and, in addition, based upon a collaborative filtering algorithm and/or a comparison of the user profiles associated with each user.

### Exemplary Embodiments & Functionality

The present embodiments relate to systems and methods that utilize artificial intelligence to provide customized electronic help. The platform may include a client device, a web server, a database server, and/or a database. The client device may display a form, such as a form-fillable webpage. The form may be displayed in conjunction with an enhanced user help tool, which may use artificial intelligence to provide help to the user as the user enters data in the form.

In one aspect, a computer system for providing enhanced user help customized to a particular user and based upon artificial intelligence may be provided. In some exemplary embodiments, the system may include a processor and a non-transitory, tangible, computer-readable storage medium having instructions stored thereon that, in response to execution by the processor, cause the processor to perform operations including: (i) generating a form-fillable webpage; (ii) providing the form-fillable webpage to a client device for display to a user; (iii) analyzing a user interaction with the form-fillable webpage; and/or (iv) providing, in response to the analyzing, customized help data to the user in the form-fillable webpage. The system may include additional, less, or alternate functionality, including that discussed elsewhere herein.

In another aspect, at least one tangible, non-transitory, computer readable storage media having computer-executable instructions embodied thereon, wherein when executed by at least one processor, the computer-executable instructions cause the processor to: (i) generate a form-fillable webpage; (ii) provide the form-fillable webpage to a client device for display to a user; (iii) analyze a user interaction with the form-fillable webpage; and/or (iv) provide, in response to the analyzing, customized help data to the user in the form-fillable webpage. The instructions may direct additional, less, or alternate functionality, including that discussed elsewhere herein.

In yet another aspect, a computer-implemented method for providing electronic help may be provided. The method may include: (i) generating a form-fillable webpage; (ii) providing the form-fillable webpage to a client device for display to a user; (iii) analyzing a user interaction with the form-fillable webpage; and/or (iv) providing, in response to the analyzing, customized help data to the user in the form-fillable webpage. The method may include additional, less, or alternate actions, including those discussed elsewhere herein.

### Machine Learning & Other Matters

The computer-implemented methods discussed herein may include additional, less, or alternate actions, including those discussed elsewhere herein. The methods may be implemented via one or more local or remote processors, transceivers, servers, and/or sensors (such as processors, transceivers, servers, and/or sensors mounted on vehicles or mobile devices, or associated with smart infrastructure or remote servers), and/or via computer-executable instructions stored on non-transitory computer-readable media or medium.

Additionally, the computer systems discussed herein may include additional, less, or alternate functionality, including that discussed elsewhere herein. The computer systems discussed herein may include or be implemented via computer-executable instructions stored on non-transitory computer-readable media or medium.

A processor or a processing element may employ artificial intelligence. For instance, the processor or processing element may be trained using supervised or unsupervised machine learning, and the machine learning program may employ a neural network, which may be a convolutional neural network, a deep learning neural network, or a combined learning module or program that learns in two or more fields or areas of interest. Machine learning may involve identifying and recognizing patterns in existing data in order to facilitate making predictions for subsequent data, including, as described herein, predictions related to data requested by an online form, such as an online form presented via a form-fillable webpage. Models may be created based upon example inputs in order to make valid and reliable predictions for novel inputs.

Additionally or alternatively, the machine learning programs may be trained by inputting sample data sets or certain data into the programs, such as image, mobile device, vehicle telematics, autonomous vehicle, and/or intelligent home telematics data. The machine learning programs may utilize deep learning algorithms that may be primarily focused on pattern recognition, and may be trained after processing multiple examples. The machine learning programs may include Bayesian program learning (BPL), voice recognition and synthesis, image or object recognition, optical character recognition, and/or natural language processing—either individually or in combination. The machine learning programs may also include natural language processing, semantic analysis, automatic reasoning, and/or machine learning.

In supervised machine learning, a processing element may be provided with example inputs and their associated outputs, and may seek to discover a general rule that maps inputs to outputs, so that when subsequent novel inputs are provided the processing element may, based upon the discovered rule, accurately predict the correct output. In unsupervised machine learning, the processing element may be required to find its own structure in unlabeled example inputs.

### Exemplary Embodiments

The present embodiments may relate an Artificial Intelligence (AI) Concierge. The AI Concierge may be a contextual system with a user interface laid over any and all web, mobile, or other digital interfaces. The AI Concierge may anticipate customer questions based upon the state of the interface and the customer's history and data. Where it detects hesitation, or if a “help” section is explicitly accessed by the user, the system surfaces the most relevant question(s), as well as a query box with auto-complete allowing the customer to interact with a dynamic database of relevant questions. When the customer selects a question, the system returns an answer constructed using the portions of answers found most relevant by previous customers, but populated with explanations and figures calculated from the current customer's data. The click/tap stream of the customer serves to refine the answer for subsequent customers. When the provided answers are not sufficient, the system escalates the question to a human insurance professional who can answer the question in a live chat. The chat transcript may also be fed into the system to refine the answer for subsequent customers.

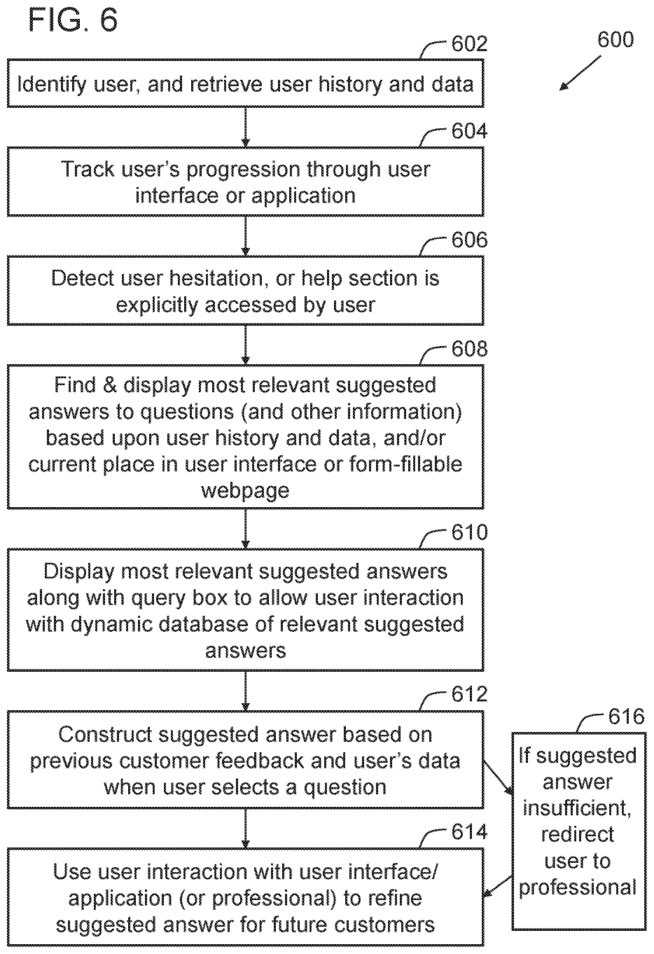

FIG. 6 illustrates an exemplary computer-implemented method of providing anticipatory user help via a user interface 600. The method 600 may include, via one or more processors, identifying a user and/or a mobile device (or user computer), and retrieving user history information and user-related data (such as one or more user profiles) 602. The method 600 may track the user's progression through a user interface and/or application 604. For instance, the application or “app” may relate to user's requesting auto or life insurance quotes, filing virtual insurance claims, filling out auto or home loan applications, etc.

The method 600 may detect user hesitation, or detect that a help screen or section of the user interface is explicitly accessed by the user 608. The method 600 may include finding and displaying on a display screen that displays a form-fillable webpage the most relevant questions and/or answers to questions (and potentially other information) based upon the user's history information and user-related data, and/or based upon the current place or location in the user interface or application 610. For instance, the method 600 may deploy artificial intelligence or machine learning to learn that a particular question, such as, for example, Question #4 on an insurance or loan application, has a larger than average probability of creating confusion for a particular type of user and/or that a particular user is hesitating or delaying in providing an answer to Question #4. When the user hesitates with Question #4 being displayed on the user interface, the most relevant questions and/or answers to questions may be those directed toward Question #4. For example, answers to Question #4 provided by other users who have answered the same question may be provided to the user as suggested answers for consideration by the user. In addition, in some embodiments, the system may analyze the user's profile (or attributes contained within the user's profile) to provide relevant or suggested answers to the question. Further, in some embodiments, the system may communicate with an external data source, such as external database, to provide one or more relevant or suggested answers to the question.

In addition to providing relevant or suggested answers, the system may additionally or alternatively provide a variety of other data to the user in response to detecting user hesitation or delay with respect to a particular question on a form-fillable webpage. For example, the system may provide one or more suggestions or prompts which may include, for example, facts or helpful tips related to a particular question, definitions (as described elsewhere herein) related to a term used in conjunction with a particular question, suggestions based upon data retrieved from an external or third party database, and the like.

For example, in one embodiment, a question provided on a form-fillable webpage that is related to an application for auto insurance may ask the user whether the user has received a traffic citation (such as a speeding ticket) within a particular period of time (such as the previous three years). The user may hesitate, potentially as a result of some uncertainty on the part of the user as to the date of the user's most recent traffic citation. The system may, in response, communicate with an external data source, such as a public records database, to obtain one or more traffic records of the user. The system may, in addition, analyze the retrieved traffic records to determine whether the user has in fact received a traffic citation within the particular period of time. Based upon the analysis, the system may provide a prompt, such as a suggestion or suggested answer, for consideration by the user. More particularly, if the user has not received such a traffic citation, the system may indicate that public records do not include a traffic citation for the user within the period of time. On the other hand, if a traffic citation appears in the public records retrieved by the system, the system may provide this information to the user to assist the user in providing an accurate answer to the question.

Similarly, and as described above, the system may provide a definition related to a term or phrase used in a question provided on a form-fillable webpage. For example, the system may include a question related to the user's garaging address (as described above). The user may hesitate or delay with respect to such a question, potentially as a result of the user's unfamiliarity with the phrase “garaging address.” In response to such hesitation or delay, the system may provide a definition or explanation of the phrase (e.g., as shown above with respect to FIG. 5).

Accordingly, when the system detects that the user is hesitating or delaying in answering a particular question, the system is configured to retrieve the most relevant questions and/or helpful answers to those questions from a database, and/or configured to display retrieved questions and/or answers on the display screen (e.g., within the form-fillable webpage) to help the user answer the question. The system may, in addition, provide one or more prompts or other helpful data, such as prompts or suggestions based upon data retrieved from an external source, definitions of terms and phrases, and the like.

The method 600 may include displaying the most relevant questions, suggested answers to questions, and/or other prompts along with a query box to allow user interaction with a dynamic database of relevant suggested answers to questions and/or prompts 610. The method 600 may include constructing and displaying a suggested answer and/or other prompts based on previous customer feedback and the user's history information and user-related data when the user selects a question 612. If the answer or other prompts are insufficient, the method 600 may redirect the user to a trained professional 616. The method 600 may also include using the user interaction with the user interface/application (and/or professional) to refine the suggested answer or prompts further for future customers 614. The method may include additional, less, or alternate actions, including those discussed elsewhere herein.

In one aspect, a computer-implemented method for providing enhanced user help customized to a particular user based upon artificial intelligence may be provided. The method may include, with the customer's permission or affirmative consent (such as via customer opt-in into a rewards, cost savings, or other program), (1) identifying, via one or more processors, a user or a user mobile device; (2) retrieving, via the one or more processors, a user profile (such as user history information or other user-related data) based upon the user's identification; (3) tracking or monitoring, via the one or more processors, the user's progression through a user interface (e.g., a fillable form displayed on a user interface) associated with a computer app or otherwise determining where in the computer app's flow the user is currently at; (4) detecting user hesitation or user-selection of help, via the one or more processors; (5) analyzing, via the one or more processors, the user profile and the current location of the user in the computer app to determine several most relevant questions, suggested answers to questions, and/or prompts that similar users may have in responding to questions at the current location to help the user respond to questions at the current location; and/or (6) displaying, via the one or more processors, the most relevant questions, suggested answers to questions, and/or prompts on the user interface to facilitate providing anticipatory help specifically chosen for a particular user.

The method may include displaying, via the one or more processors, the most relevant questions, suggested answers to questions, and/or prompts along with a query box on the user interface to facilitate allowing user interaction with a dynamic database of relevant questions, suggested answers to questions, and/or prompts. The method may include receiving, via the one or more processors, user selection of one of the most relevant questions, suggested answers to questions, and/or prompts being displayed via the user interface; constructing, via the one or more processors, a suggested answer and/or prompts based upon previous customer feedback and/or the user profile; and/or displaying, via the one or more processors, the suggested answer and/or prompt via the user interface. The method may include refining, via the one or more processors, the suggested answer and/or prompt based upon user interaction with the user interface or application for use with future customers. The method may include redirecting, via the one or more processors, the user to a professional when the suggested answer and/or prompts is deemed insufficient based upon user continued or other interaction with the user interface or application, and/or list of most relevant questions, suggested answers to questions, and/or prompts. The method may include additional, less, or alternate actions, including those discussed elsewhere herein.

In another aspect, a computer system configured to provide enhanced user help customized to a particular user based upon artificial intelligence may be provided. The system may include one or more processors configured to: identify a user or a user mobile device; retrieve a user profile (such as user history or other user data) based upon the user's identification; track or monitor the user's progression through a user interface associated with an app or otherwise determine where in the app's flow the user is currently at; detect user hesitation or user-selection of help; analyze the user profile and the current location of the user in the app to determine several most relevant questions, suggested answers to questions, and/or prompts; and/or display the most relevant questions, suggested answers to questions, and/or prompts on the user interface to facilitate providing anticipatory help specifically chosen for a particular user. The one or more processors may be further configured to display the most relevant questions, suggested answers to questions, and/or prompts along with a query box on the user interface to facilitate allowing user interaction with a dynamic database of relevant questions, suggested answers to questions, and/or prompts. The one or more processors may be further configured to: receive user selection of one of the most relevant questions, suggested answers to questions, and/or prompts being displayed via the user interface; construct a suggested answer and/or prompt based upon previous customer feedback and/or the user profile; and display the suggested answer and/or prompt via the user interface. The computer system may include additional, less, or alternate functionality, including that discussed elsewhere herein.

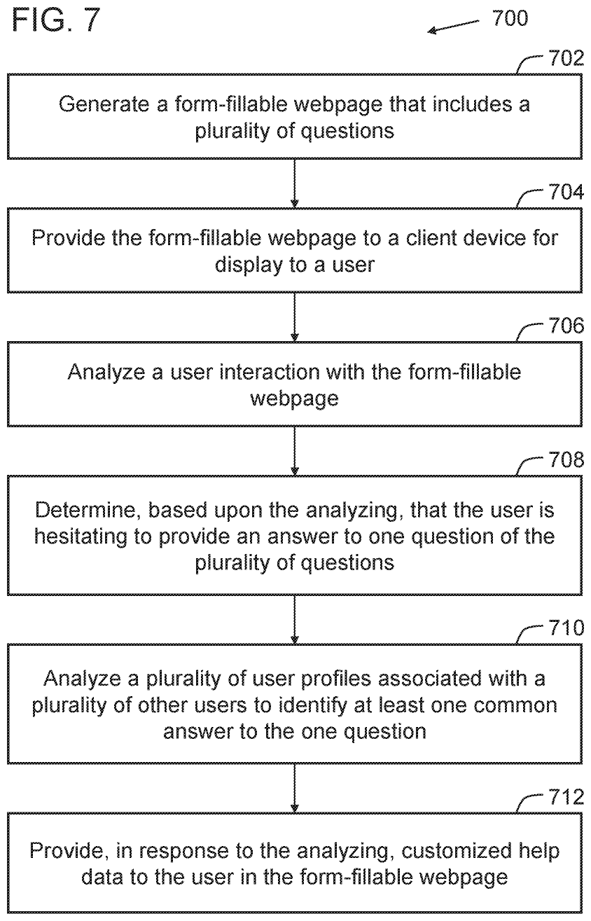

FIG. 7 illustrates an exemplary computer-implemented method 700 of providing anticipatory user help via a user interface. Accordingly, in some embodiments, a processor may generate a form-fillable webpage that includes a plurality of questions 702. The questions may include any questions associated with a form-fillable webpage, such as, for example, questions on an insurance application or questionnaire. Irrespective of the types of questions presented, however, the processor may, in addition, provide the form-fillable webpage to client device 102 for display to a user, whereupon the user may begin to provide answers, such as via client device 102, to each of the questions 704.

As the user provides answers to the questions in the form-fillable webpage, the processor may continuously monitor and/or analyze the user interaction with the form-fillable webpage 706. For instance, as described herein, the processor may determine that the user is hesitating to provide an answer to one of the questions in the plurality of questions 708. In response to such a determination, the processor may analyze a plurality of user profiles (each of which may include various user data, such as other user answers to the plurality of questions in corresponding form-fillable webpages or online questionnaires) to identify at least one common answer to the question with respect to which the current user is hesitating or delaying providing an answer 710. The processor may prompt the current user by providing this common answer (or a plurality of common answers) to the user for review and/or as part of customized help data, to assist the current user in answering the question 712.

Accordingly, the system is able to analyze other users' answers to the questions and other data associated with those other users to determine or infer what answers the current user may input. The system is further able to provide, based upon the analysis and determination, one or more suggested answers based upon data entered by and/or associated with one or more other users to the current user to assist the current user in answering one or more questions and/or otherwise filling out an online form, such as a form-fillable webpage.

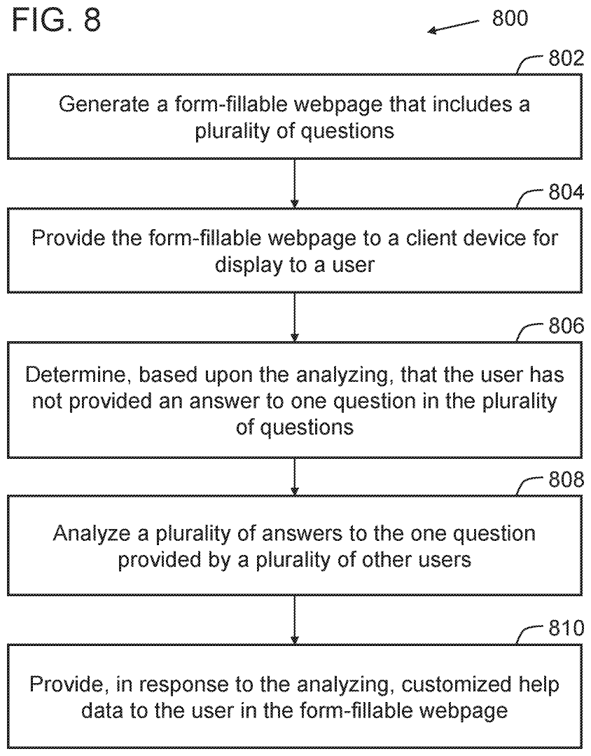

FIG. 8 illustrates an exemplary computer-implemented method 800 of providing anticipatory user help via a user interface. Accordingly, in some embodiments, a processor may generate a form-fillable webpage that includes a plurality of questions 802. The questions may include any questions associated with a form-fillable webpage, such as, for example, questions on an insurance application or questionnaire. Irrespective of the types of questions presented, however, processor may, in addition, provide the form-fillable webpage to client device 102 for display to a user, whereupon the user may begin to provide answers, such as via client device 102, to each of the questions 804.

As the user provides answers to the questions in the form-fillable webpage, the processor may continuously monitor and/or analyze the user interaction with the form-fillable webpage. For instance, as described herein, the processor may determine that the user has not provided an answer to one of the questions in the plurality of questions, such as, for example as a result of hesitation or delay in providing the answer 806. In response to such a determination, the processor may analyze a plurality of user profiles (each of which may include various user data, such as user answers to the plurality of questions in corresponding form-fillable webpages or online questionnaires) to identify a plurality of answers to the question with respect to which the current user has not provided an answer 808. The processor may provide these selected answers to the user for review and or as part of customized help data, to assist the user in answering the question 810.

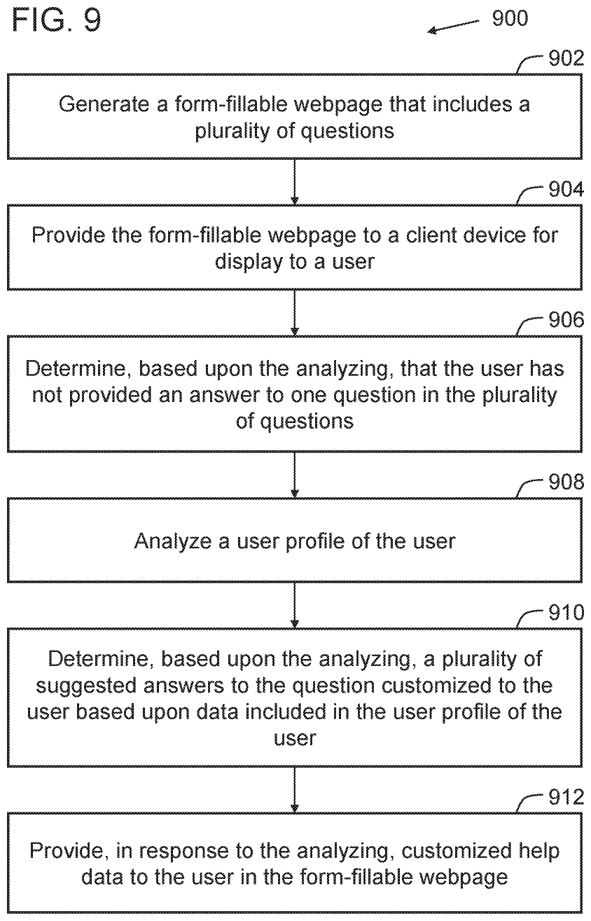

FIG. 9 illustrates an exemplary computer-implemented method 900 of providing anticipatory user help via a user interface. Accordingly, in some embodiments, a processor may generate a form-fillable webpage that includes a plurality of questions 902. The questions may include any questions associated with a form-fillable webpage, such as, for example, questions on an insurance application or questionnaire. Irrespective of the types of questions presented, however, processor may, in addition, provide the form-fillable webpage to client device 102 for display to a user, whereupon the user may begin to provide answers, such as via client device 102, to each of the questions 904.

As the user provides answers to the questions in the form-fillable webpage, the processor may continuously monitor and/or analyze the user interaction with the form-fillable webpage. For instance, as described herein, the processor may determine that the user has not provided an answer to one of the questions in the plurality of questions, such as, for example as a result of hesitation or delay in providing the answer 906. In response to such a determination, the processor may analyze a user profile of the user (which may include various personally identifying information, answers to other questions in the form-fillable webpage, answers to questions in other form-fillable webpages presented to and answered by the user, and the like) to determine a plurality of suggested answers to the question with respect to which the current user has not provided an answer 908. The processor may provide these suggested answers to the user for review and or as part of customized help data, to assist the user in answering the question 910.

Accordingly, in one aspect, a computer system for providing enhanced user help customized to a particular user and based upon artificial intelligence may be provided. In some exemplary embodiments, the system may include a processor and a non-transitory, tangible, computer-readable storage medium having instructions stored thereon that, in response to execution by the processor, cause the processor to perform operations including: (i) generating a form-fillable webpage that includes a plurality of questions; (ii) providing the form-fillable webpage to a client device for display to a user; (iii) analyzing a user interaction with the form-fillable webpage; (iv) determining, based upon the analyzing, that the user is hesitating to provide an answer to one question of the plurality of questions; (v) analyzing a plurality of user profiles associated with a plurality of other users to identify at least one common answer to the one question; and (vi) providing, in response to the analyzing, customized help data to the user in the form-fillable webpage, wherein the customized help data includes the at least one common answer to the one question. The customized help data includes any combination or subset of audible help data, textual help data, and/or video help data. The instructions may direct additional, less, or alternate actions, including those discussed elsewhere herein.

In another aspect, a computer system for providing enhanced user help customized to a particular user and based upon artificial intelligence may be provided. In some exemplary embodiments, the system may include a processor and a non-transitory, tangible, computer-readable storage medium having instructions stored thereon that, in response to execution by the processor, cause the processor to perform operations including: (i) generating a form-fillable webpage that includes a plurality of questions; (ii) providing the form-fillable webpage to a client device for display to a user; (iii) determining, based upon the analyzing, that the user has not provided an answer to one question in the plurality of questions; (iv) analyzing a plurality of answers to the one question provided by a plurality of other users; and (v) providing, in response to the analyzing, customized help data to the user in the form-fillable webpage, wherein the customized help data includes a selected number of the plurality of answers to the one question provided by the plurality of other users. The instructions may direct additional, less, or alternate actions, including those discussed elsewhere herein.

In yet another aspect, a computer system for providing enhanced user help customized to a particular user and based upon artificial intelligence may be provided. In some exemplary embodiments, the system may include a processor and a non-transitory, tangible, computer-readable storage medium having instructions stored thereon that, in response to execution by the processor, cause the processor to perform operations including: (i) generating a form-fillable webpage that includes a plurality of questions; (ii) providing the form-fillable webpage to a client device for display to a user; (iii) determining, based upon the analyzing, that the user has not provided an answer to one question in the plurality of questions; (iv) analyzing a user profile of the user; (v) determining, based upon the analyzing, a plurality of suggested answers to the question customized to the user based upon data included in the user profile of the user; and (vi) providing, in response to the analyzing, customized help data to the user in the form-fillable webpage, wherein the customized help data includes the plurality of suggested answers. The instructions may direct additional, less, or alternate actions, including those discussed elsewhere herein.

In another aspect, a computer-implemented method for providing enhanced user help customized to a particular user based upon artificial intelligence is provided. The method includes: (i) generating, by a processor, a form-fillable webpage, (ii) providing, by the processor, the form-fillable webpage to a client device for display to a user, (iii) analyzing, by the processor, a user interaction with the form-fillable webpage; and (iv) providing, by the processor and in response to the analyzing, customized help data to the user in the form-fillable webpage. The method may further include identifying, by the processor, a selected data field on the form-fillable webpage, and retrieving, by the processor, the customized help data associated with the selected data field. The method may also include analyzing, by the processor, a user profile of the user, and determining the customized help data based upon the user profile. In certain embodiments, the method includes analyzing, by the processor, a user profile of the user, executing, by the processor, a collaborative filtering algorithm based upon the user profile of the user and a plurality of other user profiles, and determining the customized help data based upon the collaborative filtering. The method may include displaying, by the processor, the customized help data in association with the selected data field. The method may include additional, less, or alternate actions, including those discussed elsewhere herein.

The form-fillable webpage may include a data field, and the user interaction may also include a delay by the user in entering data in the data field. The delay may include a threshold period of time after a time the user selects the data field, and where the delay is measured from a time that the user selects the data field to a time that the user enters data in the data field. The customized help data may include audible help data, textual help data, or video help data. The customized help data may be based upon personally identifiable information (PII) included within the user profile.

In another aspect, a computer-implemented method for providing enhanced user help customized to a particular user based upon artificial intelligence is provided. The method includes: (i) identifying, via one or more processors, a user or a user mobile device, (ii) retrieving, via the one or more processors, a user profile (such as user history or other user data) based upon the user's identification, (iii) tracking or monitoring, via the one or more processors, the user's progression through a user interface associated with an app or otherwise determining where in the app's flow the user is currently at, (iv) detecting user hesitation or user-selection of help, via the one or more processors, and (v) analyzing, via the one or more processors, the user profile and the current location of the user in the app to determine several most relevant questions, and (vi) displaying, via the one or more processors, the most relevant questions on the user interface to facilitate providing anticipatory help specifically chosen for a particular user. The method may include additional, less, or alternate actions, including those discussed elsewhere herein.

The method may further include displaying, via the one or more processors, the most relevant questions along with a query box on the user interface to facilitate allowing user interaction with a dynamic database of relevant questions. The method may also include receiving, via the one or more processors, user selection of one of the most relevant questions being displayed via the user interface, constructing, via the one or more processors, an answer based upon previous customer feedback and the user profile, and displaying, via the one or more processors, the answer via the user interface. The method may include refining, via the one or more processors, the answer based upon user interaction with the user interface or application for use with future customers and/or redirecting, via the one or more processors, the user to a professional when the answer is deemed insufficient based upon user interaction with the user interface or application, and/or list of most relevant questions.

In another aspect, a computer system configured to provide enhanced user help customized to a particular user based upon artificial intelligence is provided. The system including one or more processors configured to: (i) identify a user or a user mobile device, (ii) retrieve a user profile (such as user history or other user data) based upon the user's identification, (iii) track or monitor the user's progression through a user interface associated with an app or otherwise determine where in the app's flow the user is currently at, (iv) detect user hesitation or user-selection of help, (v) analyze the user profile and the current location of the user in the app to determine several most relevant questions, and/or (vi) display the most relevant questions on the user interface to facilitate providing anticipatory help specifically chosen for a particular user. The one or more processors may be further configured to display the most relevant questions along with a query box on the user interface to facilitate allowing user interaction with a dynamic database of relevant questions. The one or more processors may also be configured to receive user selection of one of the most relevant questions being displayed via the user interface, construct an answer based upon previous customer feedback and the user profile, and display the answer via the user interface. In certain embodiments, the one or more processors may be configured to refine the answer based upon user interaction with the user interface or application for use with future customers and/or redirect the user to a professional when the answer is deemed insufficient based upon user interaction with the user interface or application, and/or list of most relevant questions. The instructions may direct additional, less, or alternate actions, including those discussed elsewhere herein.

In another aspect, a computer system for providing enhanced user help customized to a particular user based upon artificial intelligence is provided. The system includes, a processor, and a non-transitory, tangible, computer-readable storage medium storing instructions. In response to execution by the processor, the instructions cause the processor to perform operations including: (i) generating a form-fillable webpage that includes a plurality of questions; (ii) providing the form-fillable webpage to a client device for display to a user, (iii) determining, based upon the analyzing, that the user has not provided an answer to one question in the plurality of questions, (iv) analyzing a plurality of answers to the one question provided by a plurality of other users, and (v) providing, in response to the analyzing, customized help data to the user in the form-fillable webpage, wherein the customized help data includes a selected number of the plurality of answers to the one question provided by the plurality of other users. The instructions may direct additional, less, or alternate actions, including those discussed elsewhere herein.

In another aspect, a computer system for providing enhanced user help customized to a particular user based upon artificial intelligence is provided. The system includes, a processor, and a non-transitory, tangible, computer-readable storage medium storing instructions. In response to execution by the processor, the instructions cause the processor to perform operations including: (i) generating a form-fillable webpage that includes a plurality of questions, (ii) providing the form-fillable webpage to a client device for display to a user, (iii) determining, based upon the analyzing, that the user has not provided an answer to one question in the plurality of questions, (iv) analyzing a user profile of the user, (v) determining, based upon the analyzing, a plurality of suggested answers to the question customized to the user based upon data included in the user profile of the user, and (vi) providing, in response to the analyzing, customized help data to the user in the form-fillable webpage, wherein the customized help data includes the plurality of suggested answers. The instructions may direct additional, less, or alternate actions, including those discussed elsewhere herein.

### Additional Considerations

As will be appreciated based upon the foregoing specification, the above-described embodiments of the disclosure may be implemented using computer programming or engineering techniques including computer software, firmware, hardware or any combination or subset thereof. Any such resulting program, having computer-readable code means, may be embodied or provided within one or more computer-readable media, thereby making a computer program product, i.e., an article of manufacture, according to the discussed embodiments of the disclosure. The computer-readable media may be, for example, but is not limited to, a fixed (hard) drive, diskette, optical disk, magnetic tape, semiconductor memory such as read-only memory (ROM), and/or any transmitting/receiving medium, such as the Internet or other communication network or link. The article of manufacture containing the computer code may be made and/or used by executing the code directly from one medium, by copying the code from one medium to another medium, or by transmitting the code over a network.

These computer programs (also known as programs, software, software applications, “apps”, or code) include machine instructions for a programmable processor, and can be implemented in a high-level procedural and/or object-oriented programming language, and/or in assembly/machine language. As used herein, the terms “machine-readable medium” “computer-readable medium” refers to any computer program product, apparatus and/or device (e.g., magnetic discs, optical disks, memory, Programmable Logic Devices (PLDs)) used to provide machine instructions and/or data to a programmable processor, including a machine-readable medium that receives machine instructions as a machine-readable signal. The “machine-readable medium” and “computer-readable medium,” however, do not include transitory signals. The term “machine-readable signal” refers to any signal used to provide machine instructions and/or data to a programmable processor.

As used herein, a processor may include any programmable system including systems using micro-controllers, reduced instruction set circuits (RISC), application specific integrated circuits (ASICs), logic circuits, and any other circuit or processor capable of executing the functions described herein. The above examples are example only, and are thus not intended to limit in any way the definition and/or meaning of the term “processor.”

As used herein, the terms “software” and “firmware” are interchangeable, and include any computer program stored in memory for execution by a processor, including RAM memory, ROM memory, EPROM memory, EEPROM memory, and non-volatile RAM (NVRAM) memory. The above memory types are example only, and are thus not limiting as to the types of memory usable for storage of a computer program.

In one embodiment, a computer program is provided, and the program is embodied on a computer readable medium. In an exemplary embodiment, the system is executed on a single computer system, without requiring a connection to a sever computer. In a further embodiment, the system is being run in a Windows® environment (Windows is a registered trademark of Microsoft Corporation, Redmond, Wash.). In yet another embodiment, the system is run on a mainframe environment and a UNIX® server environment (UNIX is a registered trademark of X/Open Company Limited located in Reading, Berkshire, United Kingdom). The application is flexible and designed to run in various different environments without compromising any major functionality.

In some embodiments, the system includes multiple components distributed among a plurality of computing devices. One or more components may be in the form of computer-executable instructions embodied in a computer-readable medium. The systems and processes are not limited to the specific embodiments described herein. In addition, components of each system and each process can be practiced independent and separate from other components and processes described herein. Each component and process can also be used in combination with other assembly packages and processes. The present embodiments may enhance the functionality and functioning of computers and/or computer systems.

As used herein, an element or step recited in the singular and preceded by the word “a” or “an” should be understood as not excluding plural elements or steps, unless such exclusion is explicitly recited. Furthermore, references to “example embodiment” or “one embodiment” of the present disclosure are not intended to be interpreted as excluding the existence of additional embodiments that also incorporate the recited features.

The patent claims at the end of this document are not intended to be construed under 35 U.S.C. § 112(f) unless traditional means-plus-function language is expressly recited, such as “means for” or “step for” language being expressly recited in the claim(s).

This written description uses examples to disclose the disclosure, including the best mode, and also to enable any person skilled in the art to practice the disclosure, including making and using any devices or systems and performing any incorporated methods. The patentable scope of the disclosure is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal languages of the claims.

1. A computer system for providing enhanced user help customized to a particular user based upon artificial intelligence, the computer system comprising:
a processor; and
a non-transitory, tangible, computer-readable storage medium having instructions stored thereon that, in response to execution by the processor, cause the processor to perform operations comprising:
generating a form-fillable webpage;
providing the form-fillable webpage to a client device for display to a user;
analyzing a user interaction with the form-fillable webpage, the user interaction including a delay by the user in entering a data field on the form-fillable webpage;
analyzing a user profile of the user;
executing a collaborative filtering algorithm based upon the user profile of the user and a plurality of other user profiles of a plurality of other users;
determining customized help data based upon the collaborative filtering and the user interaction by at least:
determining the customized help data to be a first help data if the delay is shorter than a threshold; and
determining the customized help data to be a second help data if the delay is longer than the threshold, the second help data being different from the first help data; and
providing, in response to the analyzing the user interaction, the customized help data to the user in the form-fillable webpage;
wherein the executing the collaborative filtering algorithm includes:
identifying one or more similar user profiles from the plurality of other user profiles which share one or more profile attributes with the user profile; and
analyzing the one or more similar user profiles to identify at least one common answer to one or more questions associated with the form-fillable webpage, the at least one common answer being frequently provided by the one or more similar user profiles, the at least one common answer including a common answer related to an address of the user;
wherein the customized help data includes the at least one common answer to the one or more questions;
wherein the one or more profile attributes includes garaging address of the user.

2. (canceled)

3. The computer system of claim 1, wherein the delay is for a threshold period of time after a time the user selects the data field.

4. The computer system of claim 1, wherein the delay is measured from a time that the user selects the data field to a time that the user enters data in the data field.

5. The computer system of claim 1, wherein the processor is further configured to perform operations comprising:
identifying a selected data field on the form-fillable webpage; and
retrieving the customized help data associated with the selected data field.

6. The computer system of claim 5, wherein the processor is further configured to perform operations comprising displaying the customized help data in association with the selected data field.

7. The computer system of claim 1, wherein the processor is further configured to perform operations comprising:
analyzing a user profile of the user; and
determining the customized help data based upon the user profile.

8. The computer system of claim 7, wherein the determining is based upon personally identifiable information (PII) included in the user profile.

9. (canceled)

10. The computer system of claim 1, wherein the customized help data is at least one selected from a group consisting of audible help data, textual help data, and video help data.

11. At least one tangible, non-transitory, computer-readable storage media having computer-executable instructions embodied thereon, wherein when executed by at least one processor, the computer-executable instructions cause the processor to:
generate a form-fillable webpage;
provide the form-fillable webpage to a client device for display to a user;
analyze a user interaction with the form-fillable webpage, the user interaction including a delay by the user in entering a data field on the form-fillable webpage;
analyze a user profile of the user;
execute a collaborative filtering algorithm based upon the user profile of the user and a plurality of other user profiles of a plurality of other users;
determine customized help data based upon the collaborative filtering and the user interaction by at least:
determining the customized help data to be a first help data if the delay is shorter than a threshold; and
determining the customized help data to be a second help data if the delay is longer than the threshold, the second help data being different from the first help data; and
provide, in response to the analyzing the user interaction, the customized help data to the user in the form-fillable webpage;
wherein to execute the collaborative filtering algorithm includes:
to identify one or more similar user profiles from the plurality of other user profiles which share one or more profile attributes with the user profile; and
to analyze the one or more similar user profiles to identify at least one common answer to one or more questions associated with the form-fillable webpage, the at least one common answer being frequently provided by the one or more similar user profiles, the at least one common answer including a common answer related to an address of the user;
wherein the customized help data includes the at least one common answer to the one or more questions;
wherein the one or more profile attributes includes garaging address of the user.

12. (canceled)

13. The computer-readable storage media of claim 11, wherein the delay is for a threshold period of time after a time the user selects the data field.

14. The computer-readable storage media of claim 11, wherein the delay is measured from a time that the user selects the data field to a time that the user enters data in the data field.

15. The computer-readable storage media of claim 11, wherein when executed by the at least one processor, the computer-executable instructions further cause the processor to:
identify a selected data field on the form-fillable webpage; and
retrieve the customized help data associated with the selected data field.

16. The computer-readable storage media of claim 15, wherein when executed by the at least one processor, the computer-executable instructions further cause the processor to display the customized help data in association with the selected data field.

17. The computer-readable storage media of claim 11, wherein when executed by the at least one processor, the computer-executable instructions further cause the processor to:
analyze a user profile of the user; and
determine the customized help data based upon the user profile.

18.-22. (canceled)

23. The computer system of claim 1, wherein, upon detecting user hesitation based at least in part upon the user interaction, the determining customized help data further includes:
establishing an external communication with a public records database;
obtaining one or more public records corresponding to the user from the public records database; and
determining the customized help data further based upon the one or more public records.

24. The computer-readable storage media of claim 17, wherein to determine the customized help data includes to determine the customized help data based upon personally identifiable information (PII) included in the user profile.

25. The computer-readable storage media of claim 11, wherein the customized help data includes at least one selected from a group consisting of audible help data, textual help data, and video help data.

26. The computer system of claim 11, wherein, upon detecting user hesitation based at least in part upon the user interaction, to determine customized help data includes to:
establish an external communication with a public records database;
obtain one or more public records corresponding to the user from the public records database; and
determine the customized help data further based upon the one or more public records.
